(19) United States
(12) Patent Application Publication
(10) Pub. No.: US 2008/0179239 A1
(43) Pub. Date: Jul. 31, 2008

(54) Thermally protected water filtration system and method of installing same

(76) Inventor: Mark W. Huelskamp, Marion, NC (US)

Correspondence Address: CARTER & SCHNEDLER, P.A., 56 CENTRAL AVENUE, SUITE 101, P.O. BOX 2985, ASHEVILLE, NC, 28802, US

(21) Appl. No.: 11/700,298

(22) Filed: Jan. 30, 2007

(51) Int. Cl. B01D 35/18; H05B 3/56

(52) U.S. Cl. 210/435; 219/535

(57) ABSTRACT

A thermally protected water filtration system including a substantially cylindrical water filter for a residential or commercial structure and a cover for fitting onto the water filter, the cover including a circumferential panel dimensioned to fit around the water filter and electrically activatable heat generating material within or attached to the circumferential panel of the cover.

### CROSS-REFERENCE TO RELATED APPLICATIONS

Not Applicable

### BACKGROUND OF INVENTION

Water filters designed to filter all the water flowing into a residential or commercial structure are commonly used when such structures rely upon water sources that provide only unfiltered and untreated water, such as well water. Such filters are commonly referred to as “whole house” water prefiltration or filtration products and typically reside in the basement or crawlspace of the structure. These areas of the structure are typically not climate-controlled; therefore, the ambient air temperature and humidity in such areas fluctuate with the weather. As a result, in geographic regions that experience subfreezing winter temperatures, the whole house water filter and the water flowing therethrough is likely to freeze, causing stoppage of the water flow into the structure and possibly damaging the filter and/or the surrounding piping. In such instances, the filter must be defrosted or replaced in order to restore the water flow into the structure. This problem could arise on multiple occasions during any given winter season.

### BRIEF DESCRIPTION OF THE DRAWINGS

FIG. 1 is a perspective view of an embodiment of the invention;

FIG. 2 is a perspective view of a sleeve embodiment of the cover of the illustrated embodiment of the invention;

FIG. 3 is a further perspective view of the sleeve embodiment of the cover of the illustrated embodiment of the invention; and

FIG. 4 is a perspective view of a wrap embodiment of the cover of the illustrated embodiment of the invention.

### DETAILED DESCRIPTION

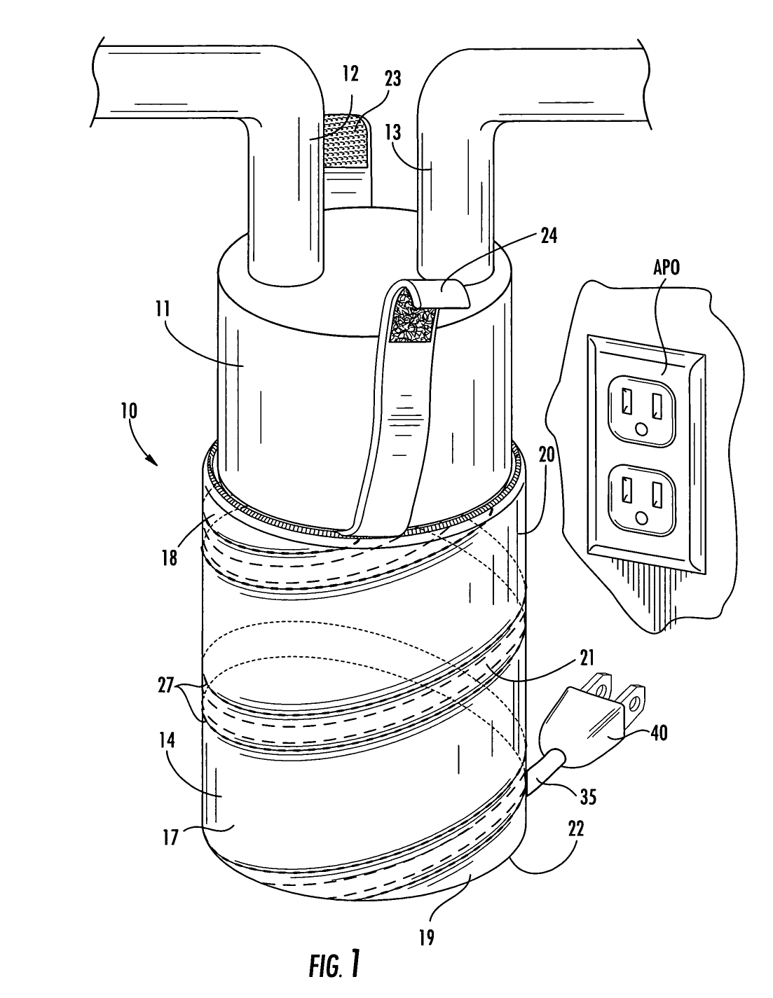

A thermally protected water filtration system according to an embodiment of the present invention is shown broadly in FIG. 1 at reference numeral 10. The system 10 comprises a substantially cylindrical water filter 11 connected between inlet and outlet pipes 12, 13 and a thermal cover 14 configured to fit over and/or around the water filter 11. The water filter 11 in the illustrated embodiment is plumbed into the water supply system for a residential or commercial structure as a “whole house” water prefiltration or filtration product and may be located in the basement or crawlspace of the structure. In order to more clearly illustrate and demonstrate the interaction of the cover 14 and the water filter 11, FIG. 1 shows the cover 14 only partially installed on the water filter 11; when the cover 14 is fully installed on the water filter 11, substantially the full length of the water filter 11 is covered by the cover 14.

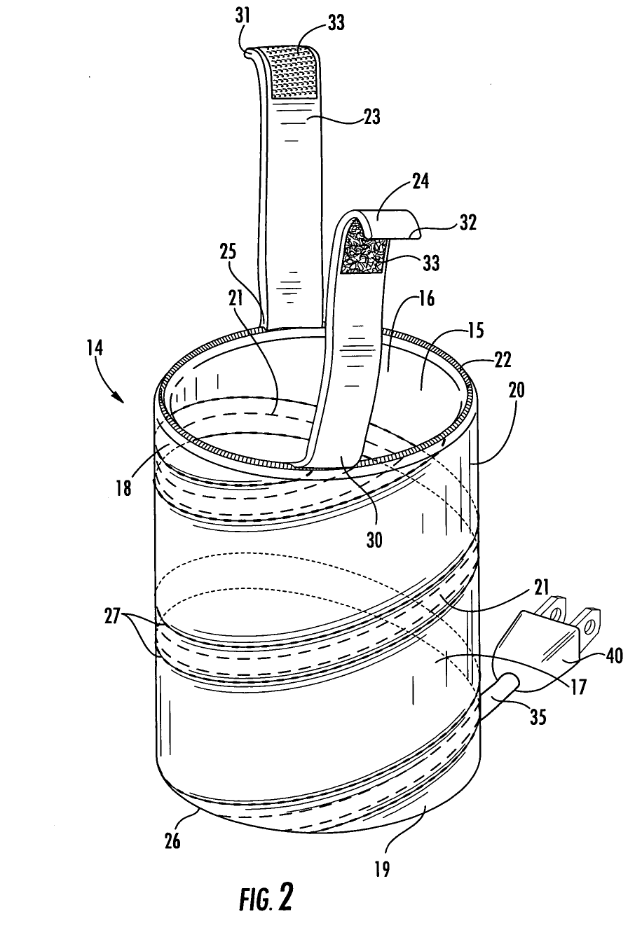

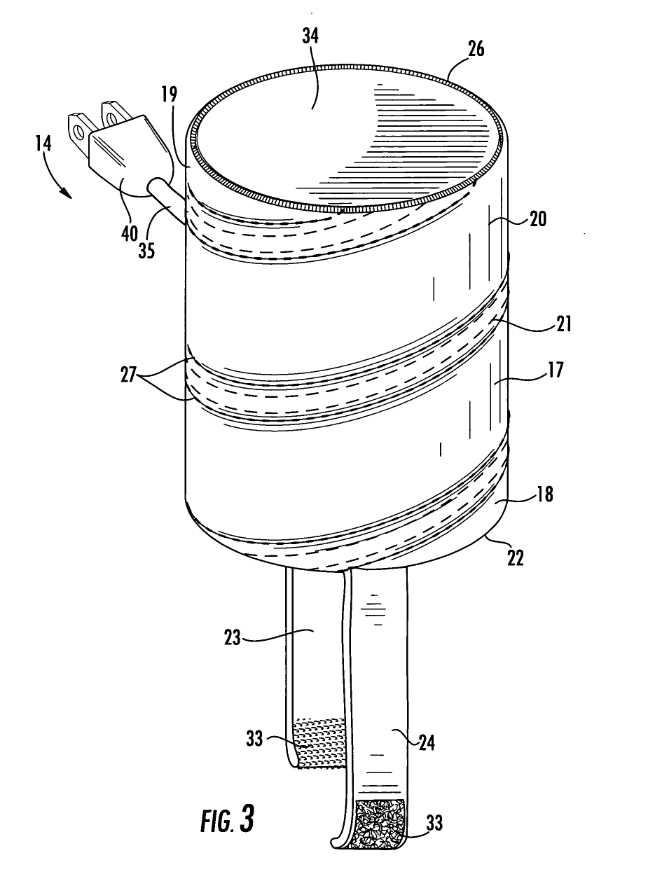

FIGS. 1, 2, and 3 illustrate a sleeve embodiment of the cover 14. The sleeve embodiment of the cover 14 comprises a bottom panel 34 (FIG. 3), a circumferential panel 17 comprising inner and outer subpanels 15, 20, a length of heating cable or heating tape 21 between the inner and outer subpanels 15, 20 of the circumferential panel 17, and a optional securement system comprising first and second straps or tethers 23, 24. The circumferential panel 17 of the cover 14 is dimensioned to fit snugly around the water filter 11. The bottom panel 34 of the cover 14 and the inner and outer subpanels 15, 20 of the circumferential panel 17 of the cover 14 may be formed of any material that adequately conducts the heat generated by the heating cable 21 without being melted, burned, or otherwise damaged by the heat; possible materials include canvas, vinyl, plastic, and neoprene. The inner subpanel 15 comprises a proximal end 16 and a distal end (not shown); the outer subpanel 20 also comprises proximal and distal ends 18, 19. The inner and outer subpanels 15, 20 of the cover 14 are sewn, fused, or otherwise joined together at proximal and distal seams 22, 26 along edges of the cover 14. In addition, the inner and outer subpanels 15, 20 are sewn, fused, or otherwise joined together along guide seams 27 sewn or otherwise formed to define a predetermined path for the heating cable 21, such as the illustrated serpentine pattern, that optimizes the coverage by the heating cable 21 of the surface area of the circumferential panel 17 of the cover 14.

The first and second straps 23, 24 of the optional securement system each comprise an attached end 25, 30 and a free end 31, 32. The attached ends 25, 30 of the first and second straps 23, 24 are attached to the cover 14 at opposing areas along or adjacent to the proximal seam 22 of the inner and outer subpanels 15, 20 of the circumferential panel 17 of the cover 14. The free ends 31, 32 of the first and second straps 23, 24 are provided with complementary hook-and-loop fasteners 33 or other adhesive or fastening materials that enable the free ends 31, 32 to be detachably attached to one another. The securement system may alternatively comprise a single strap or tether (not shown) having an attached end attached to a first area of the cover and a free end that detachably attaches with complementary hook-and-loop fasteners or other adhesive or fastening materials to an area of the cover that opposes the first area of the cover.

The bottom panel 34 (FIG. 3) of the cover 14 is sewn, fused, or otherwise joined together with the inner and outer panels 15, 20 of the circumferential panel 17 along the distal seam 26 of the cover 14. The bottom panel 34 may or may not comprise inner and outer subpanels (not shown) and be provided with heating cable (not shown).

The heating cable 21 terminates at two ends, a first end (not shown) terminating at an electrical power cable 35 that extends outside the cover 14 and terminates at an electrical plug 40, and a second end (not shown) that terminates within the cover 14. The illustrated electrical plug 40 is configured according to the 1-15 (ungrounded two-prong) or 5-15 (grounded three-prong) standards promulgated by the National Electrical Manufacturers Association, but may be configured as needed to accommodate the available heating cable and power sources. To activate the cover 14, the plug 40 is inserted into a complementary active power outlet “APO” located, for instance, on a joist or other support structure in the basement or crawlspace of the residential or commercial structure where the water filter 11 is located.

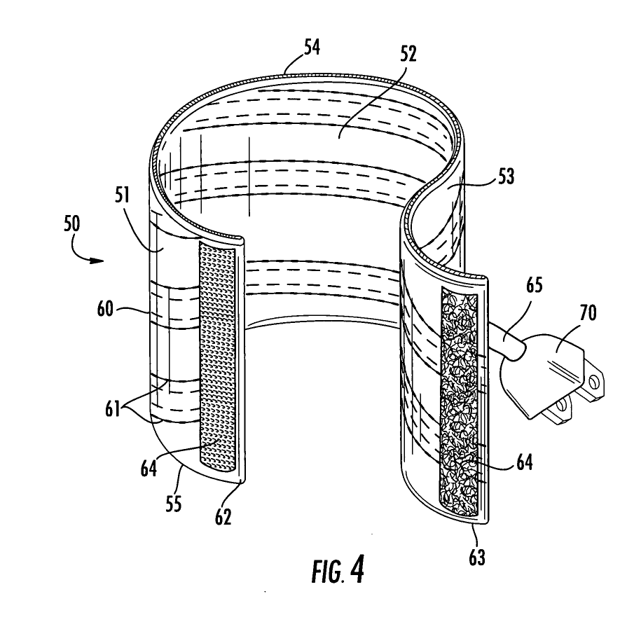

FIG. 4 illustrates a wrap embodiment of the cover 50 of the system 10 (FIG. 1). Like the sleeve embodiment of the cover 14 (FIGS. 1, 2, and 3), the wrap embodiment of the cover 50 comprises a circumferential panel 51 with inner and outer subpanels 52, 53 joined at proximal and distal seams 54, 55 and heating cable 60 within the circumferential panel 51, the heating cable 60 being oriented along a predetermined path (e.g., in a serpentine pattern, as illustrated) defined by guide seams 61 sewn or otherwise formed into the inner and outer subpanels 52, 53 of the circumferential panel 51. The circumferential panel 51 comprises first and second opposing ends 62, 63. Complementary hook-and-loop fasteners 64 or other adhesive or fastening materials are provided on the outer subpanel 53 of the first opposing end 62 of the circumferential panel 51 and on the inner subpanel 52 of the second opposing end 63 of the circumferential panel 51 to enable the opposing ends 62, 63 of the circumferential panel 51 to be detachably attached to one another. As in the sleeve embodiment of the cover 14 (FIGS. 1, 2, and 3), the heating cable 60 in the wrap embodiment of the cover 50 terminates at two ends, a first end (not shown) attached or proximal to an electrical power cable 65 that extends outside the cover 50 and terminates at an electrical plug 70, and a second end (not shown) that terminates within the cover 50. The electrical plug 70 and complementary active power outlet (not shown) in the wrap embodiment of the cover 50 are the same as those described above relative to the sleeve embodiment of the cover 14 (FIGS. 1, 2, and 3).

The heating cable 21, 60 may alternatively be any other electrically activatable heat generating material within or attached to the circumferential panel 17, 51 of the cover 14, 50 that will not damage the cover 14, 50 or the water filter 11. The heating cable discussed herein is commonly used to prevent water pipes from freezing and is therefore sometimes marketed as “pipe heating cable” or “pipe freeze protection cable.” Such heating cable may optionally include an thermostatic switch that activates and deactivates the heating cable at predetermined minimum and maximum temperatures. One manufacturer of such heating cable is Easy Heat Inc. d/b/a EasyHeat, which has a web site at www.easyheat.com with a relevant web page at http://www.easyheat.com/Content1/Products/Freeze_Protect/pfp_summary.htm.

Water filters of the type discussed herein are sometimes marketed as “whole house prefiltration” products. One manufacturer of such products is Whirlpool Corporation, which has a web site at www.whirlpool.com with a relevant web page at http://www.whirlpool.com/catalog/categoryjsp?cat=195.

The thermally protected water filtration system described above may be installed by fitting the cover onto the water filter, for instance by sliding the cover onto the water filter and attaching the straps of the securement system to one another such that the attached straps extend over the water filter (in the sleeve embodiment of the cover) or by wrapping the cover around the water filter and attaching the opposing ends of the circumferential panel of the cover to one another (in the wrap embodiment of the cover), and electrically activating the heat generating material within or attached to the circumferential panel of the cover, for instance by plugging the electrical plug of the heating cable into a complementary electrical outlet.

A thermally protected water filtration system and method of installing same are described above. Various details of the invention may be changed without departing from its scope. Furthermore, the foregoing description of embodiments of the invention and the best mode for practicing the invention are provided for the purpose of illustration only and not for the purpose of limitation—the invention being defined by the claims.

What is claimed is:

1. A thermally protected water filtration system, comprising:
a substantially cylindrical water filter for a residential or commercial structure;
a cover for fitting onto the water filter, the cover comprising
a circumferential panel dimensioned to fit around the water filter, and
electrically activatable heat generating material within or attached to the circumferential panel of the cover.

2. A system according to claim 1, wherein the circumferential panel comprises inner and outer subpanels and the heat generating material is heating cable between the inner and outer subpanels of the circumferential panel.

3. A system according to claim 2, wherein guide seams formed into the circumferential panel define a predetermined path for the heating cable.

4. A system according to claim 1, wherein the cover further comprises a bottom panel attached to the circumferential panel to form a sleeve for the water filter.

5. A system according to claim 4, wherein the cover further comprises a securement system to secure the cover on the water filter.

6. A system according to claim 5, wherein the securement system comprises first and second straps detachably attachable to one another.

7. A system according to claim 1, wherein the cover does not include a bottom panel attached to the circumferential panel and forms a wrap for the water filter.

8. A system according to claim 7, wherein the circumferential panel comprises opposing ends detachably attachable to one another.

9. A thermally protected water filtration system, comprising:
a substantially cylindrical water filter for a residential or commercial structure;
a cover for fitting onto the water filter, the cover comprising
a circumferential panel dimensioned to fit around the water filter and comprising inner and outer subpanels, and
heating cable between the inner and outer subpanels of the circumferential panel of the cover.

10. A system according to claim 9, wherein guide seams formed into the circumferential panel define a predetermined path for the heating cable.

11. A system according to claim 9, wherein the cover further comprises a bottom panel attached to the circumferential panel to form a sleeve for the water filter.

12. A system according to claim 11, wherein the cover further comprises a securement system to secure the cover on the water filter.

13. A system according to claim 12, wherein the securement system comprises first and second straps detachably attachable to one another.

14. A system according to claim 9, wherein the cover does not include a bottom panel attached to the circumferential panel and forms a wrap for the water filter.

15. A system according to claim 14, wherein the circumferential panel comprises opposing ends detachably attachable to one another.

16. A method of installing a thermally protected water filtration system, comprising:
providing a substantially cylindrical water filter for a residential or commercial structure and a cover for fitting onto the water filter, the cover comprising a circumferential panel dimensioned to fit around the water filter, and electrically activatable heat generating material within or attached to the circumferential panel of the cover;
fitting the cover onto the water filter; and
electrically activating the heat generating material.

17. A method according to claim 16, wherein the circumferential panel provided in said providing step comprises inner and outer subpanels and the heat generating material provided in said providing step is heating cable between the inner and outer subpanels of the circumferential panel and comprising an electrical plug, and wherein said electrically activating step comprises plugging the electrical plug of the heating cable into a complementary electrical outlet.

18. A method according to claim 16, wherein the cover provided in said providing step further comprises a bottom panel attached to the circumferential panel to form a sleeve for the water filter, and a securement system to secure the cover on the water filter, the securement system comprising first and second straps detachably attachable to one another, and said fitting step comprises sliding the cover onto the water filter and attaching the first and second straps to one another such that the attached straps extend over the water filter.

19. A method according to claim 16, wherein the cover provided in said providing step does not include a bottom panel attached to the circumferential panel and forms a wrap for the water filter, the circumferential panel comprises opposing ends detachably attachable to one another, and said fitting step comprises wrapping the cover around the water filter and attaching the opposing ends of the circumferential panel to one another.
